(19) United States
(12) Patent Application Publication
(10) Pub. No.: US 2014/0095579 A1
(43) Pub. Date: Apr. 3, 2014

(54) SYSTEM AND METHOD FOR INCREASING WEB SITE SERVING PERFORMANCE

(71) Applicant: VERIZON PATENT AND LICENSING INC., Basking Ridge, NJ (US)

(72) Inventors: Keyur K. Shah, Euless, TX (US); Saivivek Thiyagarajan, Ashburn, VA (US); Biplab K. Pramanik, Tampa, FL (US); Arockiapathinathan Rayappan, Chennai (IN)

(73) Assignee: VERIZON PATENT AND LICENSING INC., Basking Ridge, NJ (US)

(21) Appl. No.: 13/629,923

(22) Filed: Sep. 28, 2012

(51) Int. Cl. G06F 15/16

(52) U.S. Cl. 709/203

(57) ABSTRACT

A web document hosting device may receive, from a client device, a request for a web document via a network. The document hosting device may identify content relating to the requested web document based on the request, wherein the content includes a plurality of resource files. Minification processing may be performed on at least some of the plurality of resource files to generate minified resource files. At least some of the plurality of resource files or minified resource files may be combined into a fewer number of resource files to generate combined resource files. Compression processing may be performed on at least some of the content, the minified resource files, or the combined resource files to generate compressed resource files. At least some of the compressed resource files, the minified resource files, or the combined resource files may be transmitted to the client device via the network.

### BACKGROUND

Over the years, web sites have become increasingly complex compilations of document types, resources, and technologies. For example, a typical modern web document may include html documents, style formatting files, media files (e.g., images, videos), scripting files (e.g., JavaScript, etc.), etc. In a traditional web environment, these documents and resources are individually transmitted between the web server and the client device, resulting in a very high number of exchanges between the client and the server.

### BRIEF DESCRIPTION OF THE DRAWINGS

FIG. 1 is a diagram of an exemplary environment in which the systems and/or methods described herein may be implemented;

FIG. 2 is a block diagram illustrating exemplary components of a device of FIG. 1;

FIG. 3 is a block diagram of exemplary functional components of the document hosting system of FIG. 1 according to one implementation;

FIG. 4A depicts a portion of an exemplary configuration document;

FIG. 4B depicts an exemplary ResourceHandler file referenced by the configuration document of FIG. 4A; and

FIG. 5 is a flow diagram of an exemplary process for compressing or optimizing a document and its related documents or resources for delivery to a client device.

### DETAILED DESCRIPTION

The following detailed description refers to the accompanying drawings. The same reference numbers in different drawings may identify the same or similar elements.

As described herein, a web document compression device or application may improve web document serving performance by optimizing the manner in which particular document resources are transmitted to a requesting client device. More specifically, upon receipt of a request for a document (e.g., a web site) by a client device, the web document compression device may identify and inspect the requested web document (e.g., the files and resources associated with the requested web site). Upon inspection, the web document compression device may determine the types of optimizations that may be performed. For example, consistent with embodiments described herein, the web document compression device may 1) compress the entire web site, 2) minify or reduce the size of particular files or resources in the web site, and/or 3) collapse various web site resources into a fewer number of resources.

By optimizing the manner in which a web document is provided to a client device, the web document compression device may increase the speed with which the document is delivered to the client device and may cause client browsers send fewer requests for resources associated with the document. Consequently, the device serving the document may experience decreased network load, and the client browsers may spend less time in receiving the requested resources.

A document, as the term is used herein, is to be broadly interpreted to include any machine-readable and machine-storable work product. A document may include, for example, an e-mail, a web page or a web site, a file, a combination of files, one or more files with embedded links to other files, a news group posting, a news article, a blog, a business listing, an electronic version of printed text, a web advertisement, etc. In the context of the web (i.e., the Internet), a common document may be a web page. Documents often include textual information and may include embedded information (such as meta information, images, hyperlinks, etc.) and/or embedded instructions (such as Javascript, etc.).

A document element may include any part of a document included within a tag, such a Hypertext Markup Language (HTML) tag or an Extensible Markup Language (XML) tag. A tag may enclose, for example, text, such as a label, heading, paragraph, anchor text of a hyperlink, and/or another type of text; an input element such as a text box, a button, a radio button, a menu, a slider, a scroll bar, and/or another type of input element; an image, video, graphic, icon, and/or another type of graphical element; a tag defining a document property, such as background color, default text style, and/or another type of document property; and/or any other document element that may be enclosed by a tag.

A style specification may express how a particular element, or a particular attribute, of a document is presented to a user. For example, a style specification may define a font, text size, color, layout, text effect, highlighting, lowlighting, whether an element should be displayed, and/or another attribute by relating the attribute to a particular value. In one embodiment, the style may be specified in a style sheet language, such as, for example, the Cascading Style Sheets (CSS) language. In another embodiment, the style may be specified using another technique.

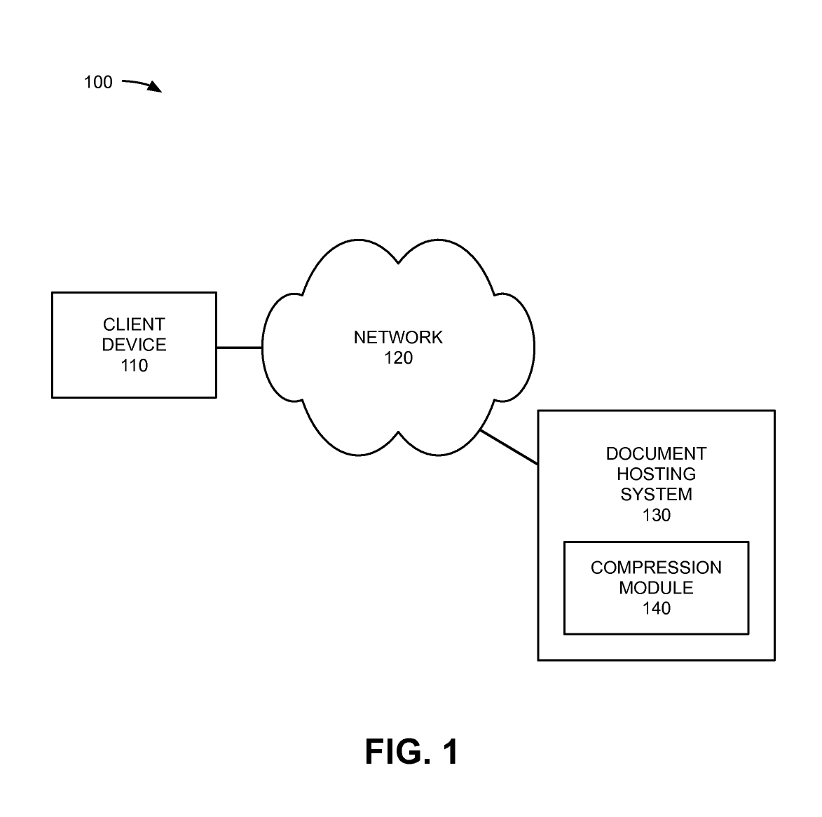

FIG. 1 is a diagram of an exemplary environment 100 in which the systems and/or methods described herein may be implemented. As shown in FIG. 1, environment 100 may include a client device 110, a network 120, and a document hosting system 130. While FIG. 1 depicts a single client device 110 and a single document hosting system 130, in practice, environment 100 may include multiple client devices 110, multiple document hosting systems 130, and/or multiple compression modules 140.

Client device 110 may include any device capable of accessing a document across a network using, for example, a browser application (e.g., Internet Explorer, Mozilla Firefox, Google Chrome, Apple Safari, Opera, etc.). Client device 110 may access a document hosted by document hosting system 130. Client device 110 may include a desktop computer; a laptop computer; a tablet computer; a mobile communication device, such as a mobile phone, a smart phone, a tablet computer, a laptop, a personal digital assistant (PDA), or another type of portable communication device; and/or another type of computation and/or communication device.

Network 120 may enable client device 110 and document hosting system 130 to communicate with each other. Network 120 may include one or more wired and/or wireless networks. For example, network 120 may include a cellular network, the Public Land Mobile Network (PLMN), a second generation (2G) network, a third generation (3G) network, a fourth generation (4G) network (e.g., a long term evolution (LTE) network), a fifth generation (5G) network, a code division multiple access (CDMA) network, a global system for mobile communications (GSM) network, a general packet radio services (GPRS) network, a combination of the above networks, and/or another type of wireless network. Additionally, or alternatively, network 120 may include a local area network (LAN), a wide area network (WAN), a metropolitan area network (MAN), an ad hoc network, an intranet, the Internet, a fiber optic-based network (e.g., a fiber optic service network), a satellite network, a television network, and/or a combination of these or other types of networks.

Document hosting system 130 may include one or more computing devices, such as server devices, that host documents. For example, document hosting system 130 may include a server device that stores a document that includes one or more elements, such as embedded media, interactive elements, etc. The document may be accessed by a user of client device 110 using a browser application, provided to client device 110, and displayed by client device 110 to the user. The user may provide input in connection with an interactive element in the document (e.g., by entering text into a text box) and client device 110 may send information associated with the input to document hosting system 130. Document hosting system 130 may store the received information and associate the received information with the interactive element and with client device 110.

Consistent with embodiments described herein, document hosting system 130 may include a compression module 140 for increasing the efficiency with which documents are provided from document hosting system 130 to client device 110. For example, as described in additional detail below, compression module 140 may be configured to intercept a request for a document (e.g., a web site) from client device 110 to document hosting system 130, identify the document based on the request, and perform compression of the identified document based on configuration information associated with the document and based on the intercepted request.

Although FIG. 1 shows exemplary components of environment 100, in other implementations, environment 100 may include fewer components, different components, differently arranged components, or additional components than depicted in FIG. 1. For example, although compression module 140 is shown as a component of document hosting system 130 in FIG. 1, in other embodiments, compression module 140 may be provisioned separated from document hosting system 130 on network 120. Additionally or alternatively, one or more components of environment 100 may perform functions described as being performed by one or more other components of environment 100.

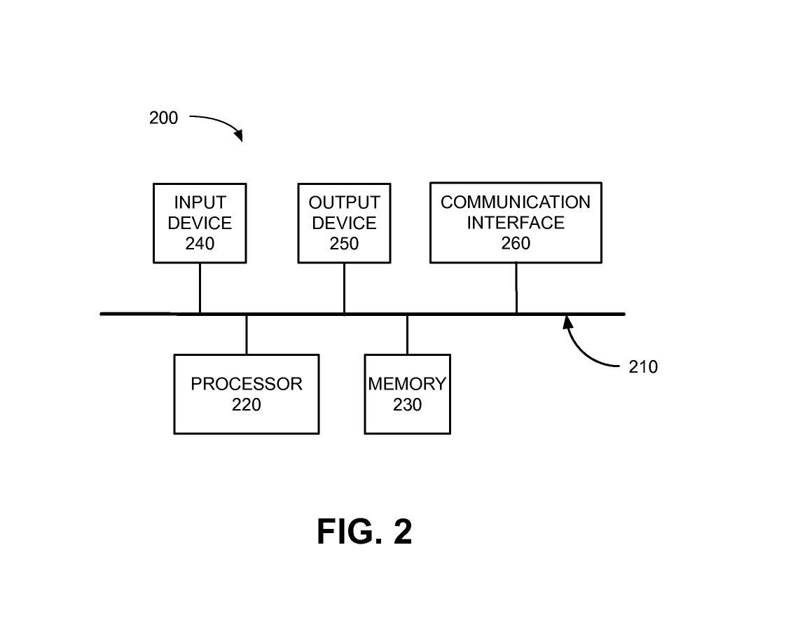

FIG. 2 is a diagram illustrating exemplary components of a device 200 according to an implementation described herein. Client device 110, document hosting system 130, and/or compression module 140 may each include one or more devices 200. As shown in FIG. 2, device 200 may include a bus 210, a processor 220, a memory 230, an input device 240, an output device 250, and a communication interface 260.

Bus 210 may include a path that permits communication among the components of device 200. Processor 220 may include any type of single-core processor, multi-core processor, microprocessor, latch-based processor, and/or processing logic (or families of processors, microprocessors, and/or processing logics) that interprets and executes instructions. In other embodiments, processor 220 may include an application-specific integrated circuit (ASIC), a field-programmable gate array (FPGA), and/or another type of integrated circuit or processing logic.

Memory 230 may include any type of dynamic storage device that may store information and/or instructions, for execution by processor 220, and/or any type of non-volatile storage device that may store information for use by processor 220. For example, memory 230 may include a random access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Input device 240 may allow an operator to input information into device 200. Input device 240 may include, for example, a keyboard, a mouse, a pen, a microphone, a remote control, an audio capture device, an image and/or video capture device, a touch-screen display, and/or another type of input device. In some embodiments, device 200 may be managed remotely and may not include input device 240. In other words, device 200 may be “headless” and may not include a keyboard, for example.

Output device 250 may output information to an operator of device 200. Output device 250 may include a display, a printer, a speaker, and/or another type of output device. For example, device 200 may include a display, which may include a liquid-crystal display (LCD) for displaying content to the customer. In some embodiments, device 200 may be managed remotely and may not include output device 250. In other words, device 200 may be “headless” and may not include a display, for example.

Communication interface 260 may include a transceiver that enables device 200 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 260 may include a transmitter that converts baseband signals to radio frequency (RF) signals and/or a receiver that converts RF signals to baseband signals. Communication interface 260 may be coupled to an antenna for transmitting and receiving RF signals.

Communication interface 260 may include a logical component that includes input and/or output ports, input and/or output systems, and/or other input and output components that facilitate the transmission of data to other devices. For example, communication interface 260 may include a network interface card (e.g., Ethernet card) for wired communications and/or a wireless network interface (e.g., a WiFi) card for wireless communications. Communication interface 260 may also include a universal serial bus (USB) port for communications over a cable, a Bluetooth™ wireless interface, a radio-frequency identification (RFID) interface, a near-field communications (NFC) wireless interface, and/or any other type of interface that converts data from one form to another form.

As will be described in detail below, device 200 may perform certain operations relating to compression and serving of documents requested by client device 110. Device 200 may perform these operations in response to processor 220 executing software instructions contained in a computer-readable medium, such as memory 230. A computer-readable medium may be defined as a non-transitory memory device. A memory device may be implemented within a single physical memory device or spread across multiple physical memory devices. The software instructions may be read into memory 230 from another computer-readable medium or from another device. The software instructions contained in memory 230 may cause processor 220 to perform processes described herein. Alternatively, hardwired circuitry may be used in place of, or in combination with, software instructions to implement processes described herein. Thus, implementations described herein are not limited to any specific combination of hardware circuitry and software.

Although FIG. 2 shows exemplary components of device 200, in other implementations, device 200 may include fewer components, different components, additional components, or differently arranged components than depicted in FIG. 2. Additionally or alternatively, one or more components of device 200 may perform one or more tasks described as being performed by one or more other components of device 200.

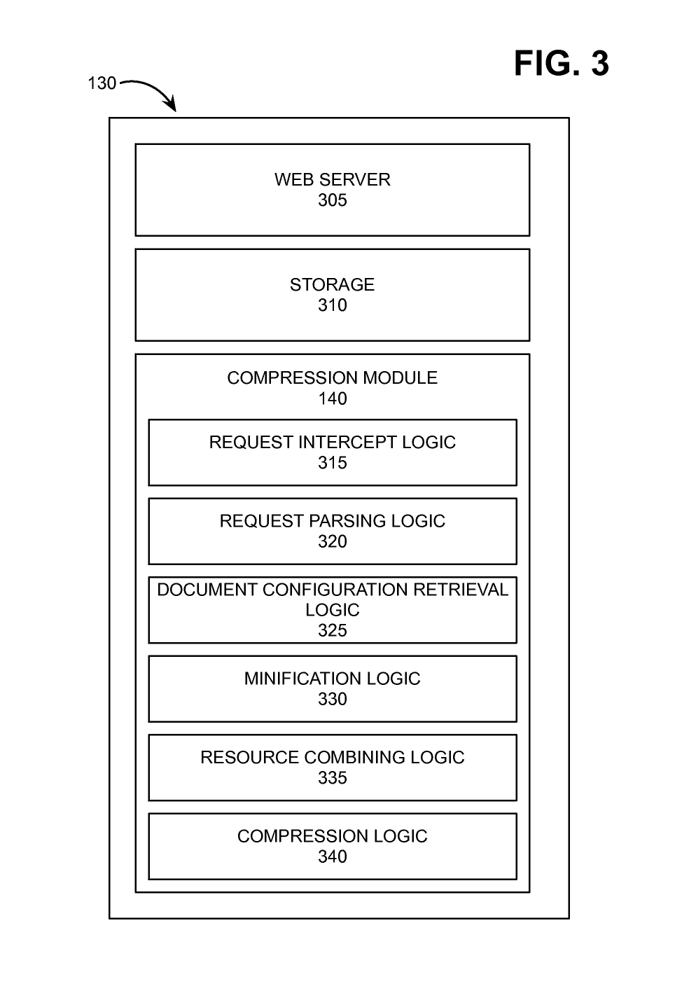

FIG. 3 is a diagram of exemplary functional components of document hosting system 130. The functional components of document hosting system 130 may be implemented, for example, via processor 220 executing instructions from memory 230. As shown in FIG. 3, document hosting system 130 may include a web server 305 and document storage 310. Furthermore, as described briefly above in FIG. 1, document hosting system 130 may further include document compression module 140. Document compression module 140 facilitates efficient delivery of one or more documents stored in document storage 310 and served by web server 305 by intercepting a request for a document and processing the document for optimized delivery based on the request and based on document configuration information associated with the requested document and stored, for example, in document storage 310. As shown in FIG. 3, compression module 140 may include request intercept logic 315, request parsing logic 320, document configuration retrieval logic 325, minification logic 330, resource combining logic 335, and compression logic 340.

Web server 305 may include logic configured to receive client requests (e.g., hypertext transfer protocol (http) requests), retrieve one or more documents based on the received request, and transmit the retrieved documents to the requesting client via network 120.

In some implementations, web server 305 may include, or may be associated with, an application server configured to serve an application, requested resources, and/or data to client device 110. Such an application server may provide services to client device 110. When the application server receives a request or notification from web server 305, the application server may provide an application for rendering the service to the browser and/or web client. The application may be already in existence, or instantiated by the application server on demand.

Document storage 310 may include one or more storage media associated with web server 305, e.g., a hard disk drive, a database, a cloud storage location, etc. Documents for delivery from web server 305 to client device 110 may be placed on (e.g., uploaded to) document storage 310 for retrieval by web server 305. In some instances, web server 305 and/or an associated application server may use data/information in document storage 310 to dynamically generate or create a web page for the browser/web client. In some implementations, document storage 310 may be updated via web server 305 or an application. As described briefly above, such documents may include multiple component elements, such as hypertext markup language (html) files, extensible markup language (xml) files, Javascript files, cascading style sheets (css) files, image and other media files, etc.

Request intercept logic 315 may intercept requests from client devices 110 to web server 305. For example, in one implementation, request intercept logic 315 may be configured to stand in the place of web server 305 with respect to received document requests. That is, request intercept logic 315 may be configured to receive document requests at the address (e.g., uniform resource locator (URL), Internet protocol (IP) address, etc.) associated with web server 305.

Once a request has been received by compression module 140 (e.g., via request intercept logic 315), request parsing logic 320 may be configured to extract information from the request that relates to compression. For example, request parsing logic 320 may be configured to extract information from the request indicative of whether client 110 supports document compression using any of a variety of different compression techniques. Consistent with embodiments described herein, request parsing logic 320 may be configured to inspect the received request to determine the type of browser or application executing on client device 110 that initiated the request. In other embodiments, request parsing logic 320 may be configured to determine whether the received request includes an Accept-Encoding field and whether the Accept-Encoding field identifies one or more supported compression types.

Based on this information, request parsing logic 320 may determine whether the identified browser or application supports document compression and, if so, the types of compression techniques supported. Exemplary compression techniques include GZip and Deflate, although any suitable compression technique may be similarly supported. As described below, compression logic 340 may uses this information to perform compression on a response to be sent to client device 110.

Request parsing logic 320 may be further configured to determine the location of the document (and any corresponding related documents), e.g., in document storage 310 based on the request. For example, the URL of the received request may indicate a location of a particular document in document storage 310.

Document configuration retrieval logic 325 may be configured to identify configuration settings associated with the requested document identified by request parsing logic 320. For example, in one implementation, each document (e.g., web page) maintained in document storage is provided with an associated configuration file or document. Consistent with embodiments, described herein, such a configuration file may be configured to include information and settings regarding the compression, minification, and resource combination capabilities of the associated document. In some implementations (e.g., Microsoft® .Net implementations), such a configuration document may be referred to as a web.config file. A web.config file is a file (e.g., an xml file) that defines configuration information regarding the web application or document with which it is associated. For example, the content of the web.config file includes information about how the web application will act, as well as information that controls module loading, security configuration, session state configuration, and application language, etc.

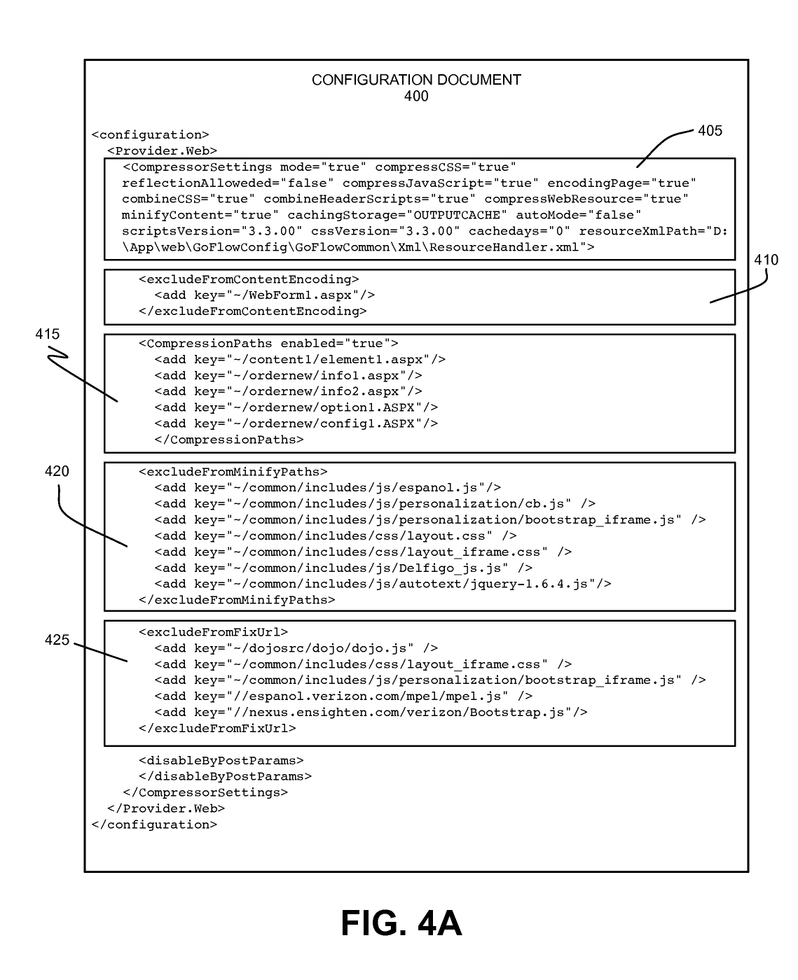

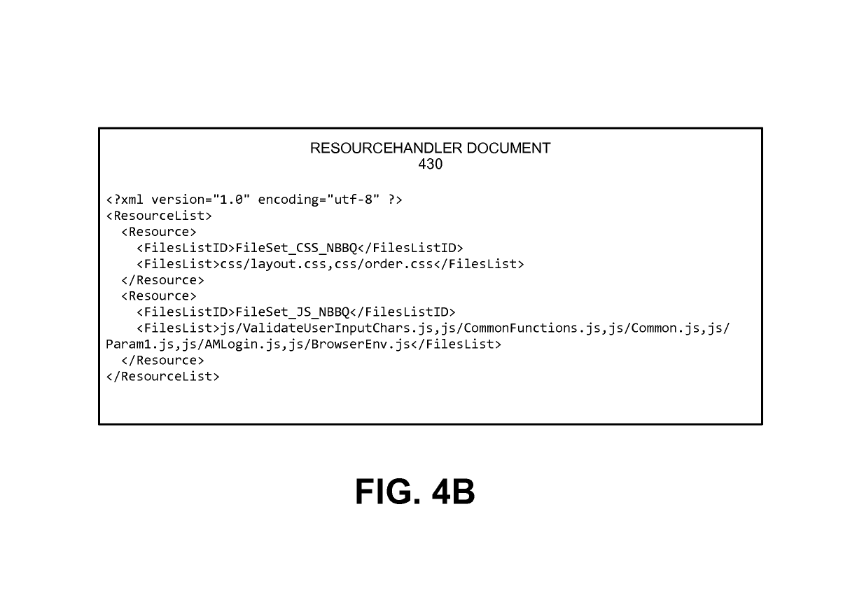

Consistent with embodiments described herein, the configuration document for a particular requested document (e.g., web page) may be configured to include information regarding compression, minification, and combination of a document and its related documents or resources. FIG. 4A depicts an exemplary portion of such a configuration document 400.

As shown in FIG. 4A, configuration document 400 includes a settings portion 405, an exclude from encoding portion 410, a compression-related portion 415, a minification-related portion 420, and a URL fix exclude portion 425. As described below, these portions of configuration document 400 collectively instruct compression module 140 regarding the content to be (or not to be) compressed, combined, or minified.

Settings portion 405 of configuration document 400 includes various attributes and their respective values relating to the operation of compression module 140. For example, as shown, in one embodiment, settings portion 405 may include, among other attributes, attributes for compressCSS, compressJavaScript, encodingPage, combineCSS, combineJavaScript, minifyContent, scriptsVersion, cssVersion, and resourceXMLPath.

The value assigned to the compressCSS attribute indicates whether CSS files associated with the requested document are to be compressed, with a value of “True” indicating that CSS files should be compressed and a value of “False” indicating that CSS files should not be compressed. Similarly, the value assigned to the compressJavaScript attribute indicates whether JavaScript files associated with the requested document are to be compressed.

The value assigned to the encodingPage attribute indicates whether the requested document and its related resources or sub-documents is to be compressed. The values assigned to the combineCSS and combineHeaderScripts attributes indicate whether multiple CSS and/or JavaScript files associated with the requested document are to be combined into single respective CSS or JavaScript files.

The value assigned to the minifyContent attribute indicates whether JavaScript and CSS files associated with the requested document are to be minified. The term “minification,” in general, refers to the removing of all unnecessary characters or spaces from a text-based document, such as an html file, an aspx file, or CSS/JavaScript files. Minified files or resources may be processed to remove all white space, all programmer comments, all new line characters, etc., leaving only content necessary to execute the file.

The value assigned to the scriptsVersion indicates a JavaScript version to be rendered in a returned URL for the associated page. By updating the JavaScript version, a rendering browser may be forced to clear any prior cached resource. Similarly, the value assigned to the cssVersion indicates a CSS version to be rendered in a returned URL for the associated page.

The value assigned to the resourceXMLPath attribute indicates an XML file that is used to collect a number of identified JavaScript and/or CSS files for combination into a single file set. If null, then all relevant resource files associated with the requested document (not otherwise excluded) may be combined into respective single resource files. FIG. 4B depicts an exemplary ResourceHandler.xml file 430 that is identified by the value of the resourceXMLPath attribute. As shown in FIG. 4B, ResourceHandler.xml file 430 identifies, for a requested document, combinations of CSS and JavaScript files for combining into respective file sets for rendering on client device 110.

Returning to FIG. 4A, exclude from encoding portion 410 includes information that identifies files or resources associated with the requested document which are excluded from processing by compression module 140. For example, exclude from encoding portion 410 indicates that the file ˜/WebForm1.aspx is to be excluded from processing.

Compression-related portion 415 includes a CompressionPaths enabled attribute, the value of which indicates whether compression is to be performed for some, all, or none of the files associated with the requested document. For example, if the value of the CompressionPaths enabled attribute is null (e.g., “ ”), compression module 140 may interpret this as instructions to compress all files and resources associated with the requested document. However, if the value of the CompressionPaths enabled attribute is true, compression module 140 may interpret this as instructions to compress only those files explicitly defined in compression-related portion 415. Conversely, if the value of the CompressionPaths enabled attribute is false, compression module 140 may interpret this as instructions to compress all files except for those explicitly defined in compression-related portion 415. In the embodiment of FIG. 4A, the CompressionPaths enabled attribute is true, thus indicating that only the files listed in compression-related portion 415 are to be compressed.

Minification-related portion 420 identifies the files or resources for which minification is not to be performed. In particular, a document author or developer may wish to prevent the minification of certain files or resources, thereby preserving the readability of the files or maintaining comment information, such as copyright or acknowledgment information.

URL fix exclude portion 425 identifies files for which URL fixing is not to be performed. As briefly described above, URLs for files may be updated to reflect an assigned “version” of CSS or JavaScript in order to force a refresh by a receiving client device 110. For example, a version number of an updated JavaScript or CSS file may file incremented (e.g., from 3.1.01 to 3.1.02) to cause the receiving browser to disregard the prior cached content and retrieve the updated data from the web server. Files or resources identified in URL fix exclude portion 425 are excluded from such updating. In some embodiments, files listed in URL fix exclude portion 425 may be excluded from all processing performed by compression module 140. In some embodiments, files or resources identified in URL fix exclude portion 425 may be removed from all compression processing.

Returning to FIG. 3, document configuration retrieval logic 325 may be configured to retrieve the configuration settings document 400 associated with the requested document and may be configured to extract relevant configuration information therefrom.

Minification logic 330 may be configured to determine whether the value of the minifyContent attribute in the retrieved configuration settings is true and, if so, whether any files or resources associated with the requested document have been excluded from minification (e.g., based on the content of minification-related portion 420 in configuration settings document 400). Based on these determinations, minification logic 330 may process the identified files or resources to remove any unnecessary characters or white spaces. The minified content may be stored, e.g., temporarily, in document storage 310 for further processing or for subsequent transmission to client device 110.

Consistent with embodiments described herein, minification logic 330 may minify the identified document or resource by initially creating a duplicate of the particular document or resource (herein after referred to simply as a resource). Minification logic 330 may then examine the duplicated resource to identify and remove any minimizable elements, such as white spaces in the resource file, new line characters, comments (e.g., content enclosed by comment tags, such as <!- - - text - - -> in html, //text or /*text*/in JavaScript and CSS, <% text %> in ASPX, etc.), and sometimes block delimiter characters. Once all removable elements have been removed, the resource file is stored and minification logic 330 continues to the next resource or document associated with the requested document (e.g., web site).

Resource combining logic 335 may be configured to determine which, if any, resources are to be combined together prior to transmission to client device 110. For example, resource combining logic 335 may determine whether the values of the combineCSS and/or combineHeaderScripts attributes in configuration settings document 400 are true. In addition, resource combining logic 335 may be configured to determine whether the resourceXMLPath attribute identifies a ResourceHandler.xml file that identifies particular CSS or JavaScript (or other resources) for combining Based on these determinations, resource combining logic 335 may process the multiple identified resources into respective single resource files. For example, in one exemplary implementation relating to a Microsoft .Net implementation, each .js (JavaScript) file and .css (CSS) file may be identified and referenced by respective single library files (e.g., jslib.axd and csslib.axd) file for reference in the document (e.g., an .aspx file) delivered to client device 110.

More particularly, when resource combining logic 335 determines that a ResourceHandler.xml file is identified in the resourceXMLPath attribute, resource combining logic 335 is configured to examine the identified ResourceHandler.xml file and determine the which JavaScript or CSS files are referenced therein. The referenced files may then be referenced or called in a respective jslib.axd and csslib.axd files.

In contrast, when resource combining logic 335 determines that no particular ResourceHandler.xml file is identified in the resourceXMLPath attribute, resource combining logic 335 is configured to identify and combine all available JavaScript or CSS files relating to the requested document and combine these files into respective jslib.axd and css.axd files.

Web server 305, when serving (e.g., in response the request from client device 110) the document that references the single library files (e.g., jslib.axd and csslib.axd), retrieves the JavaScript and CSS files referenced therein and transmits them to the requesting client device 110 during one http response. Combining resources in this manner results in a significant reduction in the number of http requests transmitted between client device 110 and web server 305 during document generation, presentation, and user interaction.

Compression logic 340 may be configured to determine whether compression should be performed and on which files or resources associated with the requested document. For example, compression logic 340 may be configured to determine whether the value of the compressCSS and/or compressJavaScript attributes indicate that CSS or JavaScript files associated with the requested document are to be compressed.

Compression logic 340 may further be configured to determine, based on the content of exclude from encoding portion 410 and compression-related portion 415, which files or resources associated with the requested document are to be compressed. Based on these determinations, as well as the information regarding compression type supported determined based on client browser or application identification (e.g., GZip or Deflate), compression logic 340 may perform the appropriate type of compression on the identified files or resources. The compressed files or resources may then be stored in document storage 310 for further processing or for subsequent transmission to client device 110.

Consistent with implementations described herein, the compressed, minified, and/or combined files and resources are then provided to web server 305 for delivery to client device 110 via network 120.

Although FIG. 3 shows exemplary functional components of document hosting system 130, in other implementations, document hosting system 130 may include fewer functional components, different functional components, differently arranged functional components, or additional functional components than depicted in FIG. 3. Additionally or alternatively, one or more functional components of document hosting system 130 may perform functions described as being performed by one or more other functional components of document styling system 130. For example, compression module 140 may execute directly on web server 305 to receive document requests from client device 110 and to transmit compressed, combined, or minified content to client device 110 following processing of compression module 140.

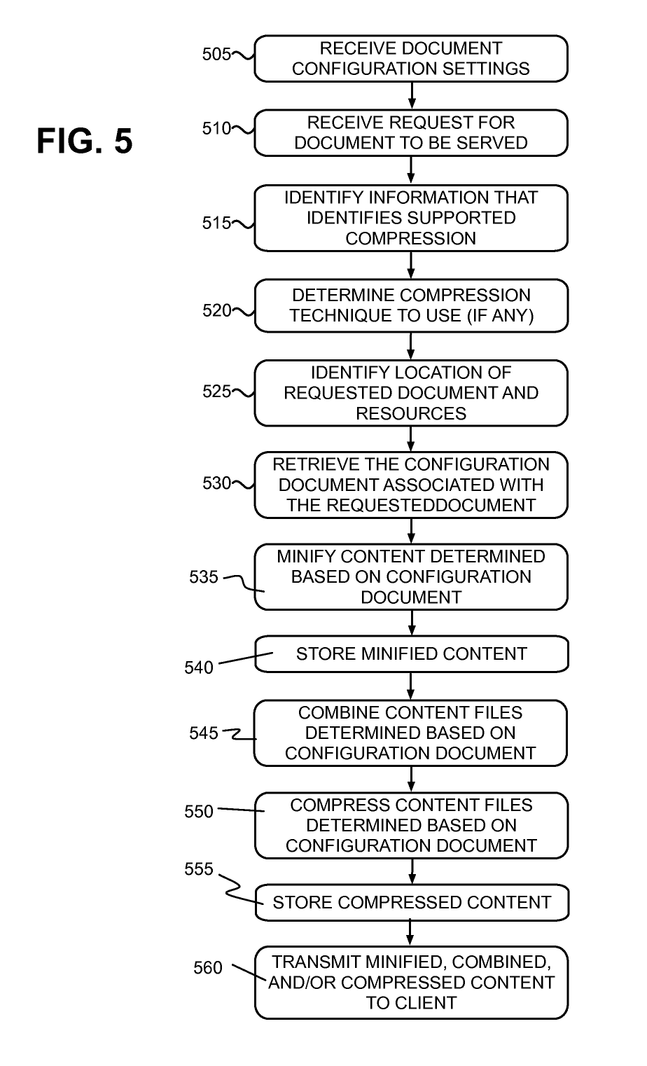

FIG. 5 is a flow diagram of an exemplary process 500 for compressing or optimizing a document and its related documents or resources for delivery to client device 110 via network 120. In one exemplary embodiment, the processing of FIG. 5 may be performed by compression module 140 and/or web server 305. Processing may begin upon receipt of a configuration document that includes compression, minification, and combination information regarding a particular document to be served (e.g., a web page) (block 505). For the purposes of this description, assume that the document to be served includes two or more resources, e.g., images, JavaScript elements, CSS, etc. which together form the document. Consistent with embodiments herein, the configuration document may be stored (e.g., in storage 310) in a location corresponding to the particular document to be served, such as in a same directory location in a file structure.

As described above in relation to FIGS. 4A and 4B, the received configuration document may include a web.config file that defines configuration settings relating to the compression, minification, and combination of the various portions of the document to be served. For example, the web.config file may include a series of parameters which indicate whether compression is to be performed and on which files or resources, whether minification is to be performed and on which files or resources, and whether script combination is to be performed and on which files resources.

In block 510, document hosting system 130 receives a request for the document to be served. For example, request intercept logic 315 in compression module 140 may receive a request for a particular web page from a client device 110 via network 120. As described above, the received request may include information that identifies a document (e.g., web site) being requested and a source of the request (e.g., browser type, application, etc.). For example, the received request may be directed to a URL associated with a particular document. Further, as one example, the received request may include an Accept-Encoding field designating GZip as a supported compression technique.

Compression module 140 extracts or identifies the information in the request that identifies supported compression techniques (block 515). For example, request parsing logic 320 may examine the received request and determine whether it includes an Accept-Encoding field and, if so, what values are included within the field. Based on this information, request parsing logic 320 determines what compression technique (if any) is to be performed (block 520).

Next, compression module 140 identifies the location (e.g., in storage 310) of the requested document, its sub-documents or resources, and the configuration document associated with the requested document (block 525). For example, request parsing logic 320 may be configured to, based on the identification information included in the request, determine a directory location on web server 305 corresponding to the requested document.

In block 530, compression module 140 may be configured to retrieve the configuration document (e.g., web.config file) associated with the requested document (e.g., stored in block 505). For example, document configuration retrieval logic may be configured to retrieve (e.g., from storage 310) the configuration document associated with the requested document (e.g., web site). As described above in relation to FIGS. 4A and 4B, the configuration document includes information that defines configuration settings relating to the compression, minification, and combination of the various portions or components of the document to be served.

In block 535, compression module 140 may be configured to minify some, all, or none of the components (e.g., resources, files, etc.) of the requested document. For example, minification logic 330 may be configured to remove unnecessary characters from the components, based on the content of the minifyContent attribute in settings portion 405 and the content of minification-related portion 420 of configuration document 400. In one embodiment, as described above in relation to FIG. 4A, the content of minification-related portion 420 identifies files or resources which are excluded from minification processing. However, in other embodiments, the opposite may be true and minification-related portion 420 may identify files or resources to be included in the minification processing.

Consistent with embodiments described herein, the output of minification logic 330 may be stored in a temporary location within storage 310 for further processing and eventual transmission to requesting client device 110 (block 540).

In block 545, compression module may be configured to combine some, all, or none of a number of disparate resources into a single resource or a reduced number of resources. For example, resource combining logic 335 may be configured to combine multiple CSS files into a single CSS file and may be configured to combine multiple JavaScript files into a single JavaScript file. Other resources may be similarly combined. Decisions relating to which (if any) resources should be combined may be based on the content of the combineCSS attribute, the combineHeaderScripts attribute, and the resourceXMLPath attribute included in settings portion 405 and the content of URL fix exclude portion 425 of configuration document 400.

In one embodiment, as described above in relation to FIG. 4A and 4B, a false value for either of the combineCSS attribute or the combineHeaderScripts causes resource combining logic 335 to not combine files of the corresponding file type. However, a null value for the resourceXMLPath attribute in the particular configuration document indicates that all respective JavaScript and CSS files are to be combined into a single resource document. For example, each .js file may be identified and combined into a single jslib.axd file for delivery to client device 110.

In the event that the value of the resourceXMLPath attribute is not null, resource combining logic 335 may be configured to retrieve the indicated file (e.g., the ResourceHandler.xml file) and combine the resources identified therein. As described above with respect to FIG. 4B, the ResourceHandler.xml file indicates the particular JavaScript or CSS files to be combined together into respective file sets.

As described briefly above in relation to FIG. 4A, in combining resource files, resource combining logic 335 may be configured to manipulate one or more version numbers in the URL associated with the combined files to thereby force client device 110 to render new content, even when prior content is stored in a browser cache of client device 110. For example, when an individual JavaScript file in a combined set of JavaScript files has been modified or updated, the URL associated with the combined set of JavaScript files may not be changed, thus permitting the recipient client device 110 to retrieve the combined set of JavaScript files from its cache rather than from document hosting system 130. To avoid this, resource combining logic 335 may be configured to, upon updating of the configuration document, replace a prior version number included in the associated URL with a new version number, thereby causing the recipient browser to retrieve the updated set of JavaScript files.

In some implementations, rather than update the configuration document upon each instance of resource modification, the configuration document may include a reference to a database value that is updated (e.g., automatically) upon modification of resource files. In this manner, the configuration document does not need to be modified for each instance of modification of an underlying resource.

At block 550, compression module 140 may be configured to compress some all or none of the documents, files, and resources associated with the requested document (e.g., web site). More specifically, compression logic 340 may initially determine whether compression should be performed and on which files or resources associated with the requested document. For example, compression logic 340 may be configured to determine whether the value of the compressCSS and/or compressJavaScript attributes indicate that CSS or JavaScript files associated with the requested document are to be compressed. In the event that such files have been previously combined (e.g., by resource combining logic 335, the combined resources may (or may not) be compressed based on the values of the compressCSS and/or compressJavaScript attributes.

Compression logic 340 may further be configured to determine, based on the content of exclude from encoding portion 410 and compression-related portion 415, which files or resources associated with the requested document are to be compressed. Based on these determinations, as well as the information regarding compression type supported determined based on client browser or application identification (e.g., GZip or Deflate), compression logic 340 may perform the appropriate type of compression on the identified files or resources.

The compressed files or resources may then be stored in document storage 310 for further processing or for subsequent transmission to client device 110 (block 555).

At block 560, document hosting system 130 transmits at least some of the compressed, minified, and/or combined files and resources associated with the requested document to the requesting client device 110. In particular, document hosting system 130 may be configured to transmit the resources referenced by the file sets created by resource combining logic 335, as described above (e.g., the jslib.axd and csslib.axd files). In transmitting these files, document hosting system 130 may be configured to retrieve the JavaScript and CSS files referenced therein and transmit them to the requesting client device 110 during one http response.

In the foregoing description, a web document compression device or module may improve web document serving performance by optimizing the manner in which particular document resources are prepared and transmitted to a requesting client device. More specifically, upon receipt of a request for a document (e.g., a web site) by a client device, a compression module may identify and inspect the requested web document (e.g., the files and resources associated with the requested web site) and may determine the types of optimizations that may be performed. Based on this determination, the web compression module may, consistent with embodiments described herein, minify or reduce the size of particular files or resources in the web site, collapse various web site resources into a fewer number of resources to reduce a number of requests transmitted between the client device and the web server, and/or compress some or all of the resources or files associated with the web site.

By optimizing the manner in which a web document is provided to a client device, the web document compression device may increase the speed with which the document is delivered to the client device and may cause client browsers send fewer requests for resources associated with the document. Consequently, the device serving the document may experience decreased network load, and the client browsers may spend less time in receiving the requested resources.

The foregoing description of implementations provides illustration, but is not intended to be exhaustive or to limit the implementations to the precise form disclosed. Modifications and variations are possible in light of the above teachings or may be acquired from practice of the teachings.

In addition, while series of blocks have been described with regard to an exemplary process illustrated in FIG. 5, the order of the blocks may be modified in other implementations. In addition, non-dependent blocks may represent acts that can be performed in parallel to other blocks. Furthermore, process 500 may include additional, fewer, or different blocks than those illustrated in FIG. 5.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

No element, act, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

What is claimed is:

1. A computing-device implemented method comprising:
receiving, from a client device, a request for a web document via a network;
identifying content relating to the requested web document based on the request, wherein the content includes a plurality of resource files;
performing minification processing on at least some of the plurality of resource files to generate minified resource files;
combining at least some of the plurality of resource files or minified resource files into a fewer number of resource files to generate combined resource files;
performing compression processing on at least some of the content, the minified resource files, or the combined resource files to generate compressed resource files; and
transmitting at least some of the compressed resource files, the minified resource files, or the combined resource files to the client device via the network.

2. The computing-device implemented method of claim 1,
receiving configuration information relating to the requested web document,
wherein the configuration information indicates which of the content are to be minified, which of the content are to be combined, and which of the content are to be compressed;
performing the minification processing based on the configuration information;
performing the combining based on the configuration information; and
performing the compression processing based on the configuration information.

3. The computing-device implemented method of claim 2, wherein the configuration information comprises a configuration document stored in a location common to at least some of the content.

4. The computing-device implemented method of claim 3, wherein the configuration document comprises one or more attributes that indicate whether minification, combining, and compression are to be performed on at least some of the content.

5. The computing-device implemented method of claim 3, wherein the configuration document comprises information indicative of particular content files to be excluded from minification, combining, or compression processing.

6. The computing-device implemented method of claim 3, wherein the configuration document includes an attribute that indicates a location of a second configuration document that indicates which of the plurality of resource files or minified resource files to combine.

7. The computing-device implemented method of claim 1, wherein the at least the some of plurality of resource files to be combined comprise at least some of a plurality of JavaScript files or at least some of a plurality of cascading style sheets files.

8. The computing-device implemented method of claim 1, further comprising:
determining, based on the request, a compression type supported by the client device.

9. The computing-device implemented method of claim 8, wherein determining the compression type support by the client device comprises determining a value associated with an Accept-Encoding field included in the received request.

10. The computing-device implemented method of claim 8, further comprising performing the compression processing based on the determined compression type supported by the client device.

11. A non-transitory computer-readable medium having stored thereon sequences of instructions which, when executed by at least one processor, cause the at least one processor to:
receive, from a client device, a request for a web document via a network;
determine that the client device supports a particular compression technique;
identify content relating to the requested web document based on the request, wherein the content includes a plurality of resource files;
perform minification processing on at least some of the plurality of resource files to generate minified resource files;
combine at least some of the plurality of resource files or minified resource files into a fewer number of resource files to generate combined resource files;
perform compression processing on at least some of the content, the minified resource files, or the combined resource files based on the particular compression technique to generate compressed resource files; and
transmit at least some of the compressed resource files, the minified resource files, or the combined resource files to the client device via the network.

12. The non-transitory computer-readable medium of claim 11, wherein the instructions, when executed by the at least one processor, further cause the at least one processor to:
receive configuration information relating to the requested web document,
wherein the configuration information indicates which of the content are to be minified, which of the content are to be combined, and which of the content are to be compressed;
perform the minification processing based on the configuration information;
perform the combining based on the configuration information; and
perform the compression processing based on the configuration information.

13. The non-transitory computer-readable medium of claim 11, wherein the configuration information comprises a configuration document stored in a location common to at least some of the content.

14. The non-transitory computer-readable medium of claim 13, wherein the configuration document comprises information indicative of particular content files to be excluded from minification, combining, or compression processing.

15. The non-transitory computer-readable medium of claim 13, wherein the configuration document includes an attribute that indicates a location of a second configuration document that indicates which of the plurality of resource files or minified resource files to combine.

16. The non-transitory computer-readable medium of claim 11, wherein the at least the some of plurality of resource files to be combined comprise at least some of a plurality of JavaScript files or at least some of a plurality of cascading style sheets files.

17. A document hosting system comprising:
a web server configured to receive a client request for web content via a network;
a storage for storing the web content; and
a compression module configured to:
determine that the client device supports a particular compression technique based on the content of the request;
identify content relating to the requested web document in the storage based on the request, wherein the content includes a plurality of resource files stored in the storage;
perform minification processing on at least some of the plurality of resource files to generate minified resource files;
combine at least some of the plurality of resource files or minified resource files into a fewer number of resource files to generate combined resource files;
perform compression processing on at least some of the content, the minified resource files, or the combined resource files based on the particular compression technique to generate compressed resource files; and
transmit at least some of the compressed resource files, the minified resource files, or the combined resource files to the client device via the network.

18. The document hosting system of claim 17, further comprising:
a configuration document stored in a location common to at least some of the content,
wherein the configuration document includes information that indicates which of the content are to be minified, which of the content are to be combined, and which of the content are to be compressed, and
wherein the compression module is further configured to:
perform the minification processing based on the information in the configuration document;
perform the combining based on the information in the configuration document; and
perform the compression processing based on the information in the configuration document.

19. The document hosting device of claim 18, wherein the configuration document comprises one or more attributes that indicate whether minification, combining, and compression are to be performed on at least some of the content.

20. The document hosting device of claim 18, wherein the configuration document comprises information indicative of particular content files to be excluded from minification, combining, or compression processing.
